(19) United States
(12) Patent Application Publication
(10) Pub. No.: US 2026/0227158 A1
(43) Pub. Date: Aug. 6, 2026

(54) Rapid deployment spectral signature management system and method for vehicles

(71) Applicant: Fibrotex Technologies Ltd., Petach-Tikva (IL)

(72) Inventor: David Kornaev, Netanya (IL)

(21) Appl. No.: 19/334,878

(22) Filed: Sep. 21, 2025

(30) Foreign Application Priority Data
Feb. 2, 2025 (IL) 318764

(51) Int. Cl. F41H 3/00; B60R 11/00; F41H 7/02

(52) U.S. Cl. CPC F41H 3/00; B60R 11/00; B60R 2011/004; B60R 2011/0059; F41H 7/02

(57) ABSTRACT

A rapid deployment spectral signature management system for vehicles, comprising at least one rapid-deployment camouflage panel featuring a manually installable and removable panel configured for multispectral camouflage, and at least one offset attachment with thickness extending between proximal and distal ends configured to maintain the camouflage panel spaced apart from the vehicle's exterior surface. Each offset attachment is secured at one end to the vehicle surface and detachably attachable at the other end to the camouflage panel by a quick-release mechanism enabling manual mounting and dismounting, or vice versa. The thickness of each offset attachment maintains an air gap between the camouflage panel and vehicle surface permitting airflow within the gap.

### CROSS-REFERENCE TO RELATED APPLICATIONS

This application claims priority to Israel Application No. 318764, titled “Rapid Deployment Spectral Signature Management System and method for vehicles”, filed Feb. 2, 2025.

### FIELD OF THE DISCLOSURE

The present disclosure relates generally to spectral signature management systems, and particularly to a system comprising multi-spectral camouflage covers for altering a spectral signature of a vehicle.

### BACKGROUND OF THE DISCLOSURE

Techniques for spectral signature management of objects were previously reported in patent literature. Depending on material composition, radiation over a wide range of frequencies (e.g., from UV through visible, IR (including Near-IR, Shortwave IR, Thermal-IR, to radio waves) can be reflected, transmitted, diffused, scattered or absorbed to affect vehicle detection. For example, U.S. Patent 10,883,800 describes a camouflage system for thermal and visual camouflage of a movable object comprising at least two frames and a plurality of reflective elements connected to each of the at least two frames. Each of the reflective elements may comprise reflective material disposed on at least one side of the reflective element and may have reflectivity of at least 85 percent in the visual range and reflectivity in the electromagnetic (EM) wavelength range of 3-5 and 8-14 microns of at least 80 percent. All of the reflective panels may be positioned in a predefined angle with respect to a vertical plane so that the upper edge of each panel is more remote from the object than the lower edge of that panel, the predefined angle is in the range of 6 to 25 degrees.

### SUMMARY OF THE INVENTION

An embodiment of the present invention that is described hereinafter provides a rapid deployment spectral signature management system for vehicles including at least one rapid-deployment panel, featuring a manually installable and removable panel configured for multispectral camouflage and at least one offset attachment. The at least one offset attachment has a thickness extending between its proximal and distal ends configured to maintain the at least one rapid-deployment camouflage panel in a position spaced apart from an exterior surface of the vehicle (“the vehicle surface”), wherein each offset attachment is: (i) either secured at a proximal end to the vehicle surface, and detachably attachable at a distal end to the at least one rapid-deployment camouflage panel by means of a quick-release mechanism operational for enabling manual mounting and dismounting of the panel, or (ii) secured at a distal end to the at least one rapid-deployment camouflage panel and detachably attachable at a proximal end to the vehicle surface by means of a quick-release mechanism operational for enabling manual mounting and dismounting to the vehicle surface, and wherein the thickness of each of the at least one offset attachment extending between its proximal and distal ends is configured to maintain an air gap between the at least one rapid-deployment camouflage panel and the vehicle surface, for permitting airflow within the air gap.

In some embodiments, the thickness of any of the at least one offset attachment extending between its proximal and distal ends varies such that the at least one panel varies in distancing, or is inclined, with respect to the vehicle surface.

In some embodiments, the thickness of any of the at least one offset attachment extending between its proximal and distal sides is constant such that the at least one rapid-deployment camouflage panel is parallel to the vehicle surface.

In an embodiment, a segmented panel of the at least one rapid-deployment camouflage panel includes two or more multi-spectral camouflage sub-panels.

In another embodiment, each of the sub-panels is oriented at a respective angle with respect to the other sub-panels.

In yet another embodiment, each of the sub-panels includes a distinct configuration of one or more multi-spectral camouflage layers of the sub-panel.

In a further embodiment, the distinct configuration of the one or more camouflage layers includes one of: distinct material composition, and distinct dimensions of the one or more layers.

In some embodiments, the at least one rapid-deployment camouflage panel includes a hanging pole, the at least one offset attachment includes compatible pole support inlets, and the at least one rapid-deployment camouflage panel is configured to be detachably attached to the at least one offset attachment by resting the pole in the support inlets.

In some embodiments, the at least one rapid-deployment camouflage panel includes a reversible double-sided panel configured to be reversibly oriented wherein each side features a different fabric suitable for a different landscape color scheme.

In an embodiment, the at least one rapid-deployment camouflage panel further includes a lower side multi-spectral camouflage section extending downwardly wherein the at least one panel lower end is directly attachable to the vehicle surface by a quick release mechanism.

In another embodiment, the at least one offset attachment includes metal brackets which are secured to the vehicle.

In some embodiments, the at least one offset attachment includes at least one polymer spacer secured to the at least one rapid-deployment camouflage panel, which is removably attachable to the vehicle surface.

In some embodiments, the system further includes lightweight shape disrupting elements which are sporadically attachable to the at least one rapid-deployment camouflage panel.

There is additionally provided, in accordance with another embodiment of the present invention, a rapid deployment spectral signature management method for vehicles, the method including providing at least one rapid-deployment camouflage panel, featuring a manually installable and removable panel for multispectral camouflage. At least one offset attachment is provided, with a thickness extending between its proximal and distal ends configured to maintain an air gap between the at least one rapid-deployment camouflage panel and an exterior surface of the vehicle (“the vehicle surface”), for permitting airflow within the air gap. The method includes securing the at least one offset attachment is secured: (i) either, at its proximal end, to the vehicle surface, or (ii) at its distal end, to the at least one rapid deployment camouflage panel. The method includes manually mounting the at least one rapid-deployment camouflage panel, which is maintained spaced apart from a vehicle surface by the at least one offset attachment, by detachably attaching the at least one offset attachment via a quick release mechanism: either (i) at its distal end, to the at least one rapid deployment camouflage panel, or (ii) at its proximal end, to the vehicle surface.

In some embodiments, the at least one rapid deployment camouflage panel is maintained spaced apart from a vehicle surface: (a) either at a distance which varies or at an inclined orientation with respect to the vehicle surface by virtue of a varying thickness of any of the at least one offset attachment, or (b) in parallel to the vehicle surface by virtue of a constant thickness of any of the at least one offset attachment.

In some embodiments, a segmented panel of the at least one rapid deployment camouflage panel, features two or more multi-spectral camouflage sub-panels. In some embodiments, each of the sub-panels cam be oriented at a respective angle with respect to the other sub-panels. In some embodiments, each of the sub-panels comprises a distinct configuration of one or more multi-spectral camouflage layers of the sub-panel. In some embodiments, the distinct configuration of the one or more camouflage layers comprises one of: distinct material composition, and distinct dimensions of the one or more layers.

In some embodiments, the step of manually mounting includes any of the following: (1) detachably attaching the at least one rapid deployment camouflage panel to the at least one offset attachment by resting a hanging pole of the at least one rapid-deployment camouflage panel in support inlets of the at least one offset attachment; (2) reversibly orienting one side of the at least one rapid-deployment camouflage panel which features reversible double-sided panel wherein each side features a different fabric suitable for a different landscape color scheme; and/or (3) directly attaching to the vehicle surface, by a quick release mechanism, a lower end of a lower side multi-spectral camouflage section extending downwardly of the at least one rapid deployment camouflage panel.

In some embodiments, the step of securing of at least one offset attachment includes securing any of the following: (1) metal brackets to the vehicle; and/or at least one polymer spacer to the at least one panel, wherein the at least one spacer is removably attachable to the vehicle surface.

In some embodiments, the method includes sporadically attaching lightweight shape disrupting elements to the at least one rapid-deployment camouflage panel.

### BRIEF DESCRIPTION OF THE DRAWINGS

The present disclosure will be more fully understood from the following detailed description of the examples thereof, taken together with the drawings, in which:

FIGS. 1A and 1B are schematic perspective views of (A) a spectral signature management system on a military vehicle, and (B) offset attachments of the system, according to an embodiment of the present invention;

FIGS. 2A and 2B are schematic, side views of multispectral camouflage panels of the spectral signature management system of FIG. 1, mounted on (A) straight offset attachments or (B) angled offset attachments, according to some embodiments of the present invention;

FIGS. 3A and 3B are schematic, orthographic views of the offset attachments and the multi-spectral camouflage panel of FIGS. 2A and 2B when attached to the offset attachments using an attachment mechanism, according to an embodiment of the present invention;

FIGS. 4A and 4B are pictorial views of panel variations and add-on attachments of the spectral signature management system of FIGS. 1A and 1B, according to some embodiments of the present invention;

FIGS. 5A and 5B are schematic, orthographic views of a multi-spectral camouflage panel of a spectral signature management system featuring an integral offset attachment, according to an embodiment of the present invention;

FIG. 6 is a flow chart that schematically illustrates a method of operation of a spectral signature management system, according to an embodiment of the present invention; and

FIG. 7 is a schematic perspective view of a spectral signature management system on a military vehicle, according to an embodiment of the present invention.

### DETAILED DESCRIPTION OF EXAMPLES

### OVERVIEW

Embodiments of the present invention that are described hereinafter provide a rapid deployment spectral signature management system for vehicles to alter (e.g., reduce) the vehicle’s spectral signature. The disclosed system is effective either when the vehicle is on the move or at a standstill. In one example, the system uses offset attachments (e.g., metal brackets) that are pre-mounted to the vehicle and multispectral camouflage panels that can be manually installable and removable by detachably attaching to the offset attachments in the field. In another example, each panel is fixedly attached to one or more offset attachments (adaptors, spacers), and the combined unit can be manually installable and removable by detachably attaching to the vehicle. In this context, terms such as ‘installing,’ ‘attaching,’ ‘affixing,’ ‘mounting,’ ‘assembling,’ ‘positioning,’ ‘deploying,’ and the like synonyms, are interchangeably used herein. In this context, a distinction can be made between ‘manual installation’ by a user, which does not require installation equipment. Manual installation refers to a process where the user can set up or assemble the system basically using only their hands, without the need for specialized tools or devices, whose operation also slows down the installation process. Manual installation typically involves simple actions such as snapping, clicking, or slotting components into place, making the installation process straightforward and accessible to individuals without technical expertise.

In one embodiment, the system includes at least one rapid deployment camouflage panel, featuring a manually installable and removable panel configured for multi-spectral camouflage, and at least one offset attachment for maintaining the camouflage panel in a position spaced apart from an exterior surface of the vehicle (“the vehicle surface”). The thickness of any of the at least one offset attachment extending between its proximal and distal ends is configured to maintain an air gap between the at least one camouflage panel and the vehicle surface, for permitting airflow within the air gap. The air gap assists in breaking the vehicle's sidewall spectral signature, such as its thermal and radar signatures.

In one option, any of the at least one offset attachment is secured at a proximal end to the vehicle surface, and detachably attachable at a distal end by means of a quick-release mechanism operational for enabling manual mounting and dismounting of the at least one rapid deployment camouflage panel.

In another option, the at least one offset attachment is secured at a distal end to the at least one rapid deployment camouflage panel, and detachably attachable at a proximal end to the vehicle surface by a quick-release mechanism operational for enabling manual mounting and dismounting to the vehicle surface. Such distal securement can be, for example, used with lightweight offset attachments, such as attachments including polymer.

In some embodiments, the offset attachments (e.g., metal brackets) are attached (e.g., screwed) in advance to designated anchoring ports (e.g., holes) disposed on the surface of the vehicle in a way that ensures no impact on functionality or maneuverability of the vehicle. The mounted offset attachments allow rapid manual field deployment of the multi-spectral camouflage panels.

Using modular detachable panels lets the user access vehicle locations, such as opening (e.g., unscrewing) lids to perform maintenance of sub-systems of the vehicle and to refuel and lubricate the vehicle. The modular panel may be left hanging over the offset attachments but folded to that end.

The offset attachments (e.g., brackets, polymer made spacers) and the panels can be designed as segmented panels to orient two or more sub-panels of each segmented panel at an angle in between (i.e., one sub-panel being angled relative to the other sub-panel), which results, for example, in optimized reflectivity of emissive signatures, negating cold sky reflectance as well as near-field false emissivity issues. Even when using straight brackets, the air gap breaks some elements (e.g., thermal, RADAR) of the spectral signature of the panel, which reduces its spectral signature area.

Alternatively, or additionally to tilting sub-panels and/or using an air gap, segmented panels may be used, wherein each panel comprises two or more multi-spectral camouflage sub-panels wherein each sub-panel includes different layer designs (e.g., distinct material composition and /or dimensions of at least one layer) to break the larger spectral signature area of the panel into that of smaller areas of the sub-panels.

Removal of the offset attachments allow keeping the original layout of anchoring points on the vehicle available for the operators or the manufacturer to use in other applications (e.g., adding an armor layer therein).

Sometimes, the air gap volume can be used to store equipment in containers (e.g., of tools, food, water, etc.) The containers can be attached to the vehicle wall using available anchoring points or with straps configured for fastening to some types of the offset attachments, such as brackets. Some light equipment, e.g., rucksacks, can be hung on or fastened over the panels.

A user can easily adjust the panels in the field to suit different landscapes such as desert, urban, woodland and arctic environments, e.g., by covering the panel with specially printed fabric, while maintaining vehicle function and maneuverability.

Lightweight shape disrupting elements can be sporadically attached to the panels, in a pattern unique to each particular vehicle (e.g., randomly selected by the user in each deployment), to divert from consistent or characteristic pattern, figurine, contour, and shape (e.g., rectangular outlines), making it difficult for AI-based pattern/shape/reflectance analysis tools which assist aid in detecting or classifying the camouflaged vehicle presence or functionality (e.g., classifying as a specific purpose military vehicle).

In an embodiment, one or more offset attachments of lightweight material (e.g., polymer blocks), are secured at a distal side to the at least one rapid deployment multi-spectral camouflage panel, and detachably attachable for allowing manual deployment and dismounting by a quick release mechanism at a proximal side to the vehicle surface. The lightweight offset attachments are also configured to create the air gap. The one or more lightweight offset attachments are configured to be rapidly attachable by manual operation to the vehicle’s side walls (or removed) using members (e.g., metal connectors) fitted on the offset attachment. The panel is fixedly attached (e.g., glued) to the one or more offset attachments (e.g., spacers).

In another embodiment, the one or more lightweight material offset attachments are attached to the vehicle’s side walls using hook-and-loop fasteners. The panel is either permanently affixed to the one or more offset attachments or is detachably attached by hook-and-loop fasteners.

### RAPID DEPLOYMENT SPECTRAL SIGNATURE MANAGEMENT SYSTEM DESCRIPTION

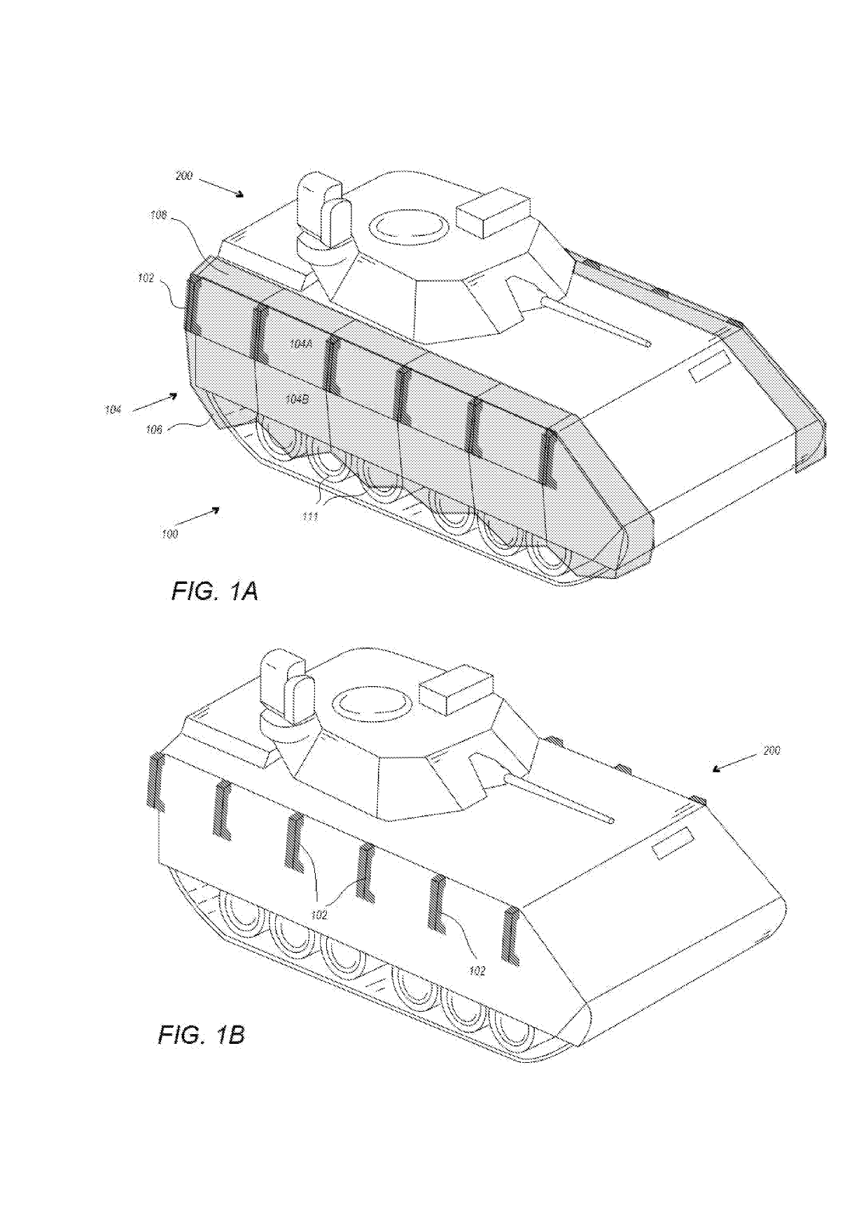

FIGS. 1A and 1B are schematic perspective views of (A) a spectral signature management system 100 on a military vehicle 200, and (B) offset attachments 102 of system 100, according to an embodiment of the present invention.

Offset attachments 102 (e.g., brackets 102) are pre-mounted on vehicle 200 (e.g., attached in advance to field deployment of the vehicle) to existing designated ports (e.g., holes) in the surface of vehicle 200, wherein brackets 102 are configured to generate an air gap once being covered with panels, while ensuring no impact on functionality or maneuverability.

Spectral signature altering panels 104 are quickly assembled over the fixed adaptors, with the resulting air spacing between vehicle 200 walls and the panels reducing thermal and radar signatures while still maintaining vehicle 200 function and maneuverability.

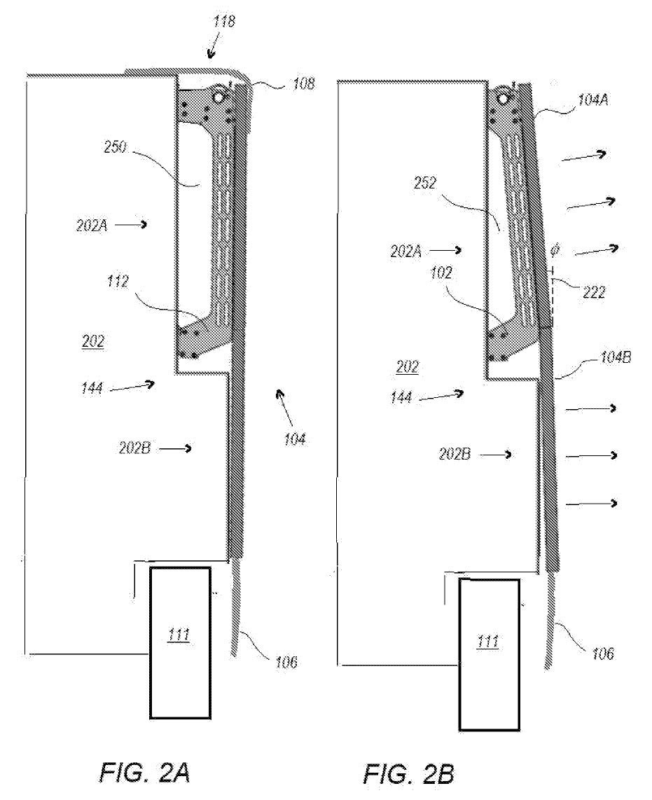

The brackets and the panels can be designed to allow sub-panels (104A, 104B) of each panel 104 to be oriented at an angle one with respect to the other, as described in FIG. 2B, to allow, for example, optimized reflectivity of emissive signatures, negating cold sky reflectance as well as near-field false emissivity issues.

A lower side multi-spectral camouflage section 106, which may be made of a flexible or drapable sheet, dangles from panel 104. Camouflage sections 106 can break wheels 111 imprints and/or attenuate a heat signature escaping from below the vehicle.

An additional element of camouflage system 100 seen in FIG. 1A are top sheets 108 attached to panels 104 that conceal the sharp straight imprint of the edge of the vehicle’s side wall.

FIG. 1 is brought by way of example. In other embodiments, light-weight offset attachments, such as light material ones, are attached to the vehicle using quick release mechanism. The lightweight offset attachments are also shaped to allow the air gap. The panels are fixedly attached to the spacers, creating the air gap.

### MULTI-SPECTRAL CAMOUFLAGE PANELS MOUNTED ON OFFSET ATTACHMENTS

FIGS. 2A and 2B are schematic side views of multi-spectral camouflage panels 104 of the spectral signature management system 100 of Fig.1 mounted on (A) straight offset attachments 112 (e.g., metal brackets 112) or (B) angled offset attachments 102 (e.g., metal brackets 102), according to some embodiments of the present invention.

Panels 104 provide multi-spectral camouflage to the sidewall 202 facet of vehicle 200, with sub-panel 104A altering the spectral signature of a facet 202A and sub-panel 104B altering the spectral signature of a facet 202B. Due to either formed air gaps 250 or 252 (variable width air gap), the spectral signature of sub-panel 104A differs from that of sub-panel 104B, which breaks the spectral signature of vehicle 102 sidewall 202.

For example, sub-panel 104A reflect the skies’ cold Thermal signature while sub-panel 104B reflects a warmer near-distant environment like ground, bushes, trees and more… by that, the 104A and 104B sub-panel will result with a different SWIR and Thermal (mid and long wave) signature, UV signature, and NIR signature, and make the “noise” needed to blend into and merge with the environment. The effectiveness of such an approach per given distance to an observer largely depends on sub-panel size and the spatial resolution of the observation means.

In FIG. 2B, the thickness of offset attachment 102 extends between its proximal and distal sides varies such that sub-panel 104A varies in distancing, or is inclined, with respect to the vehicle surface. Using angled bracket 102 results in an angle f 222 between sub-panels 104A and 104B, which is helpful in breaking the spectral signature of panel 104 into two distinct smaller spectral signatures. The partition of panel 104 into two or more sub-panels 104A and 104B enables panel 104 to accept the shape created by angled brackets 102 so as to form the angle f between the sub-panels.

Panel 104 comprises a plurality of layers (not shown) adapted to reduce electrooptic reflectance and electromagnetic radiation reflected, scattered, or emitted from vehicle 200 sidewall 202. Panels 104 may be made of light and at least semi-rigid or rigid thin material, adapted to provide the required rigidity for supporting the multi-spectral camouflaging layers.

Different sub-panels of each panel may use different multi-spectral camouflaging layer designs (e.g., distinct material composition and/or dimensions of at least one layer) to break the effective signature area of panel 104 into that of sub-areas of panels 104A and 104B.

While FIGS. 2A and 2B show panels and brackets suited for a stepped (114) sidewall 202, other bracket and panel solutions may be installed on straight walls or wedged walls, yielding a similar multi-spectral camouflaging effect by creating either an air gap under portion (e.g., sub-panel) of the panel, an angle j between two or more sub-panels, or use distinct material composition and/or dimensions of each sub-panel, or a combination of the above.

The partition into sub-panels also enables easy stowing of the main facet section into relatively small packages when not deployed and easy deployment when preparing the vehicle for operation.

Lower side multi-spectral camouflage section 106 provides coverage from the bottom of the panel down and close to the ground underneath it. Lower side section 106 may be made of a thin, flexible or drapable sheet of cloth or insulating plastic and may be covered, e.g., printed or embedded with UV, Near-IR, Shortwave-IR and Thermal-IR and visual reflecting and/or absorbing type of material. Inter alia, the role of lower section 106 is to block IR leakage stemming from the heat produced by, for example, the operating engine of the vehicle and/or wheels’ traction heat.

Upper section camouflage panel 108 may be directed mainly to conceal the upper typically straight lines of vehicle 200, which become highly visible/noticeable in a battlefield. Section 108 may have holes 118 in to let heat escape up and outside the air gap.

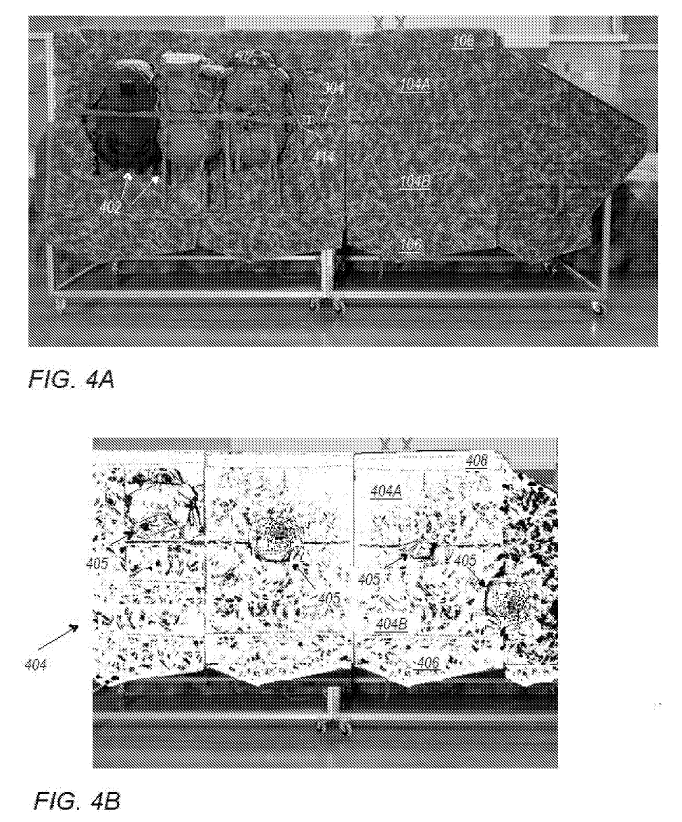

Lower section 106 and the upper section panel 108 may be relatively narrow and very light-weight portions that may not need to be capable of folding or stowing when not in use. However, typically, the main section 104 is adapted to be folded (into the sub-panels shape) and to be easily deployed when in need, described in FIG. 4.

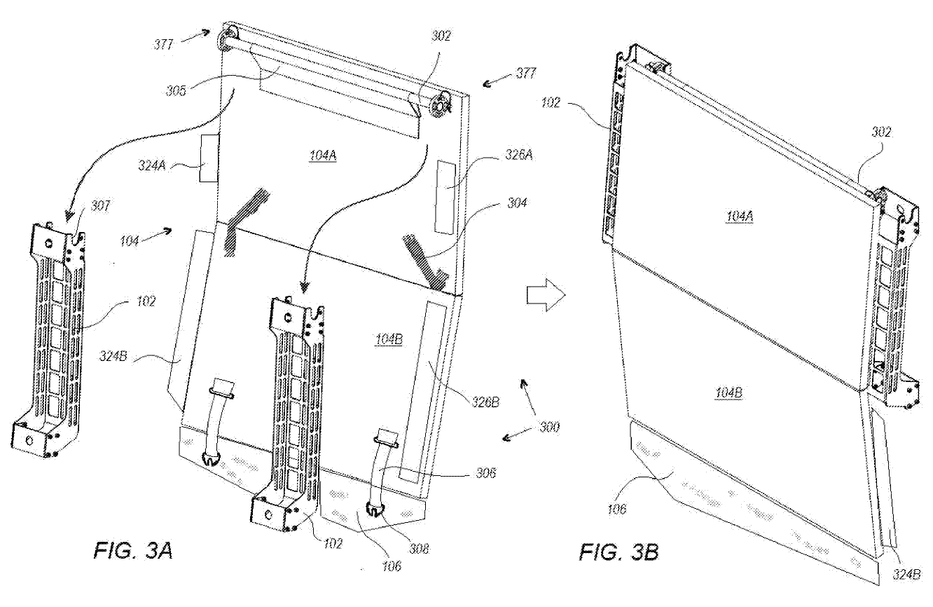

FIGS. 3A and 3B are schematic orthographic views of the attachment of multi-spectral camouflage panel 104 of FIG. 2 to offset attachments (e.g., brackets 102) on vehicle 200 of FIG. 1 using attachment mechanism 300, according to an embodiment of the present invention.

As part of attachment mechanism 300, panel 104 comprises a sleeve 305 and a poll 302 inside the sleeve. A user quickly assembles the panel over the fixed brackets by sliding poll 302 into semi-circle inlets 307. The poll is secured to the inlets at its two ends using two securing pins 377.

Each panel 104 can be secured to the bottom of the vehicle using ratchet straps 306 with hooks 308. The same ratchet straps 306 can be used in a folded configuration of the panel to secure panel 104 to brackets (e.g., in a fast deployment-ready configuration). In this configuration, sub-panel 104B is folded onto sub-panel 104A and secured to brackets 102 by the ratchet straps 306. The folded deployment-ready keeps the assembled panel surface clean and protected while the panels are ready for immediate deployment.

Hook-and-loop fasteners (324, 326), such as ones made by Velcro, are used for joining two neighboring panels. In FIG. 3A, to this end, Velcro elements 324A and 324B of one panel 104 can be attached to the Velcro elements 326A and 326B, respectively, of the neighboring panel 104.

Side release buckle straps 304 can be used to secure equipment (e.g., rucksack) to the panels, as shown in FIG. 4A. Alternatively, for heavier payload, ratchet straps can be used and be connected directly to metal brackets 102.

FIG. 3 is brought by way of example. Another mechanism other than ratchet straps 306 with hooks 308 can be used, for example, to secure the panel to the lower section of the vehicle.

FIG. 4A and 4B are schematic, pictorial drawings of panel variations and add-ons 405 (e.g., pattern disrupting elements 405) to the camouflage system 100 of FIG. 1, according to some embodiments of the present invention.

FIG. 4A shows a fully deployed system 100 on the side wall of a vehicle. Side release buckle straps 304 with straps 414 are used to secure rucksacks 402 to the panels. Alternatively, for heavier loads, ratchet straps can be used and be connected directly to metal brackets 102.

FIG. 4B shows a fully deployed system 100 in a snowy camouflage on the side wall of a vehicle. In the shown example, a dominantly white colored fabric 404 is attached to each of panels 104 so that the outer painting camouflage scheme is suitable for the snowy and Arctic landscape. In one embodiment, the panel has a place with several kinds of fabrics 404 to pull from and cover the panel according to changing landscapes.

In FIG. 4, lightweight (e.g., meshed fabric) disrupting elements 405 are sporadically attached to panels 404 to break any consistent patterns and more so, shape (e.g., rectangular and/or Semi-Circle outlines), making it difficult for AI-based pattern/shape/reflectance analysis tools to aid in inferring the camouflaged vehicle presence or functionality (e.g., as a specific purpose military vehicle).

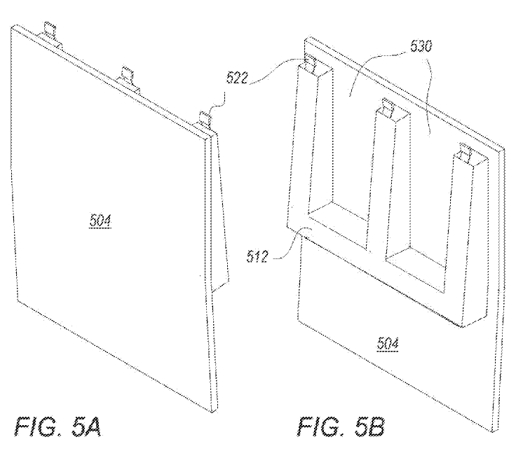

FIGS. 5A and 5B are schematic, orthographic views of a multi-spectral camouflage panel 504 of the spectral signature management system 100 of Fig.1 mounted on one offset attachment 512, according to an embodiment of the present invention. Offset attachment 512 is fitted with three quick release mechanisms 522 to attach the panel on the vehicle wall.

Multi-spectral camouflage panel 504 and offset attachment 512 are configured for holding the multi-spectral camouflage panel 504 spaced apart from a vehicle surface. While FIGS. 5A and 5B show a monolithic panel 504 (e.g., continuous), in another example a segmented panel may be used, such as a panel divided into two sub-panels as described above.

In the shown example, panel 504 is shaped to have an angled portion. Offset attachment 512 is shaped to support the angled panel. In another example, the panel is straight and so is the offset attachment.

The thickness of any of the at least one offset attachment 512 extending between its proximal and distal sides is configured to maintain an air gap 530 between panel 504 and the vehicle surface, allowing airflow within the air gap 530.

In FIGS. 5A and 5B, offset attachment 512 is secured at a distal side to the multi-spectral camouflage panel 504, and can be detachably attached by the quick release mechanism 522 at a proximal side to the vehicle surface.

In another embodiment, the camouflage panel comprises a reversible double-sided panel configured to be reversibly oriented wherein each side features a different fabric suitable for a different landscape color scheme.

### METHOD OF RAPIDLY DEPLOYING SPECTRAL SIGNATURE MANAGEMENT SYSTEM

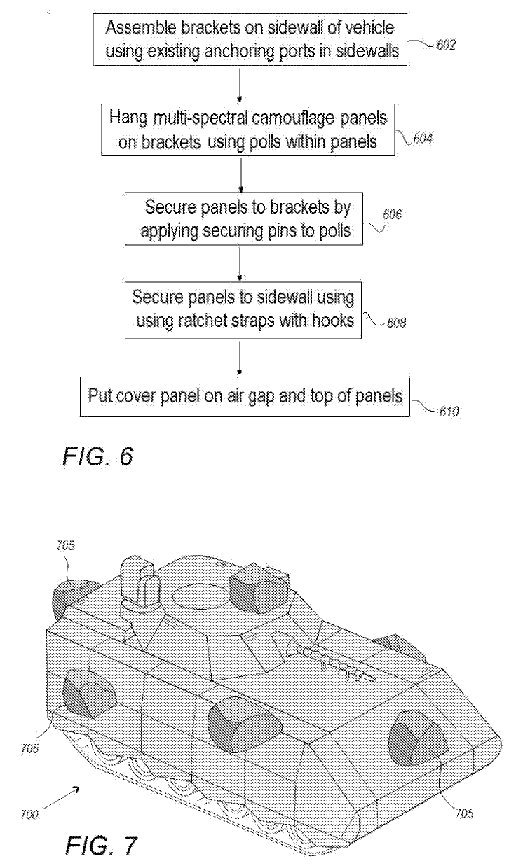

FIG. 6 is a flow chart that schematically illustrates a method of operation of spectral signature management system 100 of FIG. 1, according to an embodiment of the present invention. Namely, at least one rapid-deployment camouflage panel, featuring a manually installable and removable panel for multispectral camouflage is preliminarily provided. In addition, at least one offset attachment is preliminarily provided. The offset attachment has a thickness extending between its proximal and distal ends, configured to maintain an air gap between the at least one rapid-deployment camouflage panel and the vehicle surface, thus permitting airflow within the air gap. Thereafter, The process begins by assembling brackets 102 on the sidewalls 202 of vehicle 200 at bracket assembly step 602, exemplifying a general step of securing the offset attachment at its proximal end to the vehicle surface. In other embodiments, an alternative general may feature securing the offset attachment at its distal end, to the at least one rapid-deployment camouflage panel. This step may be performed during routine with the brackets becoming part of the vehicle, to save time when spectral signature management system rapid assembly is required in the field.

Thereafter, the system is ready for the manual, rapid-deployment phase, by which the panel is manually mounted by detachably attaching the offset attachment at its distal end to the panel. with a quick release mechanism (while maintained spaced apart from a vehicle surface by the offset attachment). At panel assembly step 604, the panels are hung by the polls 302 on the brackets. The user puts multispectral camouflage panels into a stowed position (stowed in the sense of arranged neatly and securely for deployment), tight one to each neighboring panel by sliding the poll into inlets 307 of brackets 102. In one embodiment, the multi-spectral camouflage panel comprises a hanging pole 302 and the offset attachment comprises compatible pole support inlets 307, and the multi-spectral camouflage panel is configured to be detachably attached to the offset attachment by resting the pole in the support inlets, as seen in FIG. 3B. Pole 302 and inlets 307 exemplify a quick release mechanism.

In alternative embodiments, wherein the offset attachment is secured at its distal end to the panel, the panel is manually mounted by detachably attaching the offset attachment at its proximal end to the vehicle surface with a quick release mechanism (while maintained spaced apart from a vehicle surface by the offset attachment).

Using Velcro elements 324A, 324B, and 326A, 326B, the operator joins any two neighboring panels to perfect the continuous and extended camouflage.

The user secures the panels to the brackets by applying securing pins 377 to the polls, at panels securing step 606.

Next, the user secures the bottom portion of the panels to the vehicle using ratchet straps 306 with hooks 308, at ratcheting step 608.

The user attaches the cover panels 108 to panels 104 to finalize camouflage system 100, at an over-covering step 610.

FIG. 6 is brought by example and is brief for clarity. Additional steps may be performed, such as attaching rucksacks and camouflage add-ons, as described in FIG. 4. The

### SPECTRAL SIGNATURE MANAGEMENT SYSTEM WITH SHAPE DISRUPTORS

FIG. 7 is a schematic perspective view of a spectral signature management system 700 on a military vehicle, according to another embodiment of the present invention. Shape disruptors 705 are sporadically attached to the multi-spectral panels to break any consistent patterns and more so, shape (e.g., rectangular and/or Semi-Circle outlines), making it difficult for AI-based pattern/shape/reflectance analysis tools to aid in inferring the camouflaged vehicle presence or functionality (e.g., as a specific purpose military vehicle).

Shape disruptors 705 can be attached to the panels at varied location, to vary signature between vehicles or between deployments over a same vehicle. shape disruptors 705 can be configured to generate spectral print (e.g., IR signature), that breaks the expected signature of the vehicle.

It will be appreciated that the embodiments described above are cited by way of example and that the present disclosure is not limited to what has been particularly shown and described hereinabove. Rather, the scope of the present disclosure includes both combinations and sub-combinations of the various features described hereinabove, as well as variations and modifications thereof which would occur to persons skilled in the art upon reading the foregoing description and which are not disclosed in the

1. A rapid deployment spectral signature management system for vehicles, comprising:
at least one rapid-deployment camouflage panel, featuring a manually installable and removable panel configured for multispectral camouflage;
at least one offset attachment with a thickness extending between its proximal and distal ends configured to maintain the at least one camouflage panel in a position spaced apart from an exterior surface of the vehicle (“the vehicle surface”), wherein each offset attachment is:
secured at a proximal end to the vehicle surface, and detachably attachable at a distal end to the at least one rapid-deployment camouflage panel by a quick-release mechanism operational for enabling manual mounting and dismounting of the panel; or
secured at a distal end to the at least one rapid-deployment camouflage panel and detachably attachable at a proximal end to the vehicle surface by a quick-release mechanism operational for enabling manual mounting and dismounting to the vehicle surface, and
wherein the thickness of each of the at least one offset attachment, extending between its proximal and distal ends is configured to maintain an air gap between the at least one rapid-deployment camouflage panel and the vehicle surface, for permitting airflow within the air gap.

2. The system according to claim 1, wherein the thickness of any of the at least one offset attachment extending between its proximal and distal ends is constant or varies such that the at least one panel is respectively in parallel, or varies in distancing, or is inclined, with respect to the vehicle surface.

3. The system according to claim 1, wherein a segmented panel of the at least one rapid-deployment camouflage panel comprises two or more multi-spectral camouflage sub-panels.

4. The system according to claim 3, wherein each of the sub-panels is oriented at a respective angle with respect to the other sub-panels.

5. The system according to claim 3, wherein each of the sub-panels comprises a distinct configuration of one or more multi-spectral camouflage layers of the sub-panel.

6. The system according to claim 5, wherein the distinct configuration of the one or more camouflage layers comprises one of: distinct material composition, and distinct dimensions of the one or more layers.

7. The system according to claim 1, wherein the at least one rapid-deployment camouflage panel comprises a hanging pole, the at least one offset attachment comprises compatible pole support inlets, and the at least one rapid-deployment camouflage panel is configured to be detachably attached to the at least one offset attachment by resting the pole in the support inlets.

8. The system according to claim 1, wherein the at least one rapid-deployment camouflage panel comprises a reversible double-sided panel configured to be reversibly oriented wherein each side features a different fabric suitable for a different landscape color scheme.

9. The system according to claim 1, wherein the at least one rapid-deployment camouflage panel further comprises a lower side multi-spectral camouflage section extending downwardly wherein the lower end of the section is directly attachable to the vehicle surface by a quick release mechanism.

10. The system according to claim 1, wherein the at least one offset attachment comprises metal brackets which are secured to the vehicle.

11. The system according to claim 1, wherein the at least one offset attachment comprises at least one polymer spacer secured to the at least one rapid-deployment camouflage panel, which is removably attachable to the vehicle surface.

12. The system according to claim 1, comprising lightweight shape disrupting elements which are sporadically attachable to the at least one rapid-deployment camouflage panel.

13. A rapid deployment spectral signature management method for vehicles, comprising:
providing at least one rapid-deployment camouflage panel, featuring a manually installable and removable panel for multispectral camouflage;
providing at least one offset attachment, having a thickness extending between its proximal and distal ends, the offset attachment being configured to maintain an air gap between the at least one rapid-deployment camouflage panel and an exterior surface of the vehicle (“the vehicle surface”), for permitting airflow within the air gap;
securing the at least one offset attachment:
at its proximal end, to the vehicle surface; or
at its distal end, to the at least one rapid-deployment camouflage panel; and
manually mounting the at least one rapid-deployment camouflage panel, which is maintained spaced apart from a vehicle surface by the at least one offset attachment, by detachably attaching the at least one offset attachment by a quick release mechanism:
at its distal end, to the at least one rapid deployment camouflage panel; or
at its proximal end, to the vehicle surface.

14. The method according to claim 13, wherein the at least one rapid deployment camouflage panel is maintained spaced apart from a vehicle surface at a distance which is parallel, or varies, or at an inclined orientation with respect to the vehicle surface by virtue of a respectively constant or varying thickness of any of the at least one offset attachment.

15. The method according to claim 13, wherein the manually mounting comprises detachably attaching the at least one rapid deployment camouflage panel to the at least one offset attachment by resting a hanging pole of the at least one rapid-deployment camouflage panel in support inlets of the at least one offset attachment.

16. The method according to claim 13, wherein the manually mounting comprises reversibly orienting one side of the at least one rapid-deployment camouflage panel which features reversible double-sided panel wherein each side features a different fabric suitable for a different landscape color scheme.

17. The method according to claim 13, wherein the manually mounting comprises directly attaching to the vehicle surface, by a quick release mechanism, a lower end of a lower side multi-spectral camouflage section extending downwardly of the at least one rapid deployment camouflage panel.

18. The method according to claim 13, wherein the securing of at least one offset attachment comprises securing metal brackets to the vehicle.

19. The method according to claim 13, wherein the securing of at least one offset attachment comprises securing at least one polymer spacer to the at least one panel, wherein the at least one spacer is removably attachable to the vehicle surface.

20. The method according to claim 13, comprising sporadically attaching lightweight shape disrupting elements to the at least one rapid-deployment camouflage panel.
